(19) United States
(12) Patent Application Publication
(10) Pub. No.: US 2016/0306175 A1
(43) Pub. Date: Oct. 20, 2016

(54) VISUAL INFORMATION TECHNOLOGY DEVICE

(71) Applicant: Kabushiki Kaisha Toshiba, Tokyo (JP)

(72) Inventors: Hirofumi Morita, Higashiyamato Tokyo (JP); Shinichi Kido, Hamura Tokyo (JP)

(21) Appl. No.: 14/932,143

(22) Filed: Nov. 4, 2015

(30) Foreign Application Priority Data
Apr. 14, 2015 (JP) 2015-082258

(51) Int. Cl. G02B 27/01

(52) U.S. Cl. CPC G02B 27/0176; G02B 27/0172; G02B 2027/014; G02B 2027/0138

(57) ABSTRACT

According to one embodiment, a visual information technology device includes a head mounted display, and an information processor. The information processor includes an image display, a camera, a case, and a heat transfer member which detours around the camera and conducts heat emitted from the image display. The heat transfer member includes a first portion that is between the image display and the camera and receives heat emitted from the image display, and a second portion that continuously extends from the first portion and radiates heat having been received in the first portion.

### CROSS-REFERENCE TO RELATED APPLICATIONS

This application is based upon and claims the benefit of priority from Japanese Patent Application No. 2015-082258, filed Apr. 14, 2015, the entire contents of which are incorporated herein by reference.

### FIELD

Embodiments described herein relate generally to a head-worn visual information technology device.

### BACKGROUND

A visual information technology device which is worn on a user's head, acquires any information, including characters, static images, and dynamic images, and allows the user to visually recognize the information is known. For example, some glasses type visual information technology devices have in addition to a module for displaying images a camera which has an image pickup device, including a complementary metal oxide semiconductor (CMOS) and a charge-coupled device (CCD). Image pickup devices, such as CMOSs, tend to be affected by temperature, and the temperature range for correct operation is specified. Consequently, when a camera is used in an environment which deviates from an operating temperature range established for a guarantee of operation, image quality may deteriorate, and it may be impossible to demonstrate its original performance. Temperature and heat management should therefore be carried out.

It should be noted that there is a head-worn visual information technology device which not only has an image display as a head mount display but also carries a camera, and yet ensures a visual field as a wearable terminal. Since it is attached to the head, various devices must be assembled into a lightweight and small-sized system. As a result, a camera may have to be arranged adjacent to a picture display panel which is one of heat sources. There is apprehension that a camera may be exposed to a temperature environment exceeding operation ensuring temperature because of receiving heat radiated from the picture display panel for a long time.

Therefore, it is desirable to provide a visual information technology device which gives consideration to the operation ensuring temperature of the camera arranged near the heat source.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating a visual information technology device in a first embodiment.

FIG. 2 is an exemplary perspective view illustrating the information processor of the first embodiment which is in a state of being disassembled into component parts.

FIG. 3 is an exemplary transparent view illustrating the internal structure of the information processor of the first embodiment.

FIG. 4 is an exemplary perspective view illustrating a camera lens holding section of the case of the first embodiment.

FIG. 5 is an exemplary view illustrating the heat transfer member of the first embodiment in a cross-section parallel to the horizontal plane.

FIG. 6 is an exemplary perspective view illustrating the heat transfer member of the first embodiment from a viewpoint other than that of FIG. 3.

FIG. 7 is an exemplary perspective view illustrating a heat transfer member in a second embodiment.

FIG. 8 is an exemplary perspective view illustrating a heat transfer member in a third embodiment.

FIG. 9 is an exemplary perspective view illustrating a heat transfer member in a fourth embodiment.

FIG. 10 is an exemplary perspective view illustrating a heat transfer member in a fifth embodiment.

### DETAILED DESCRIPTION

Various embodiments will be described hereinafter with reference to the accompanying drawings. In general, according to one embodiment, a visual information technology device in an embodiment includes a head mounted display configured to be worn by a user; and, and an information processor attached to the head mounted display. The information processor includes an image display to project a picture on user's eyes, a camera to capture images including a user's visual field, a case containing the image display and the camera, and a heat transfer member attached to the image display. The heat transfer member includes a first portion between the image display and the camera to receive heat emitted from the image display, and a second portion extending from the first portion to radiate the heat received by the first portion.

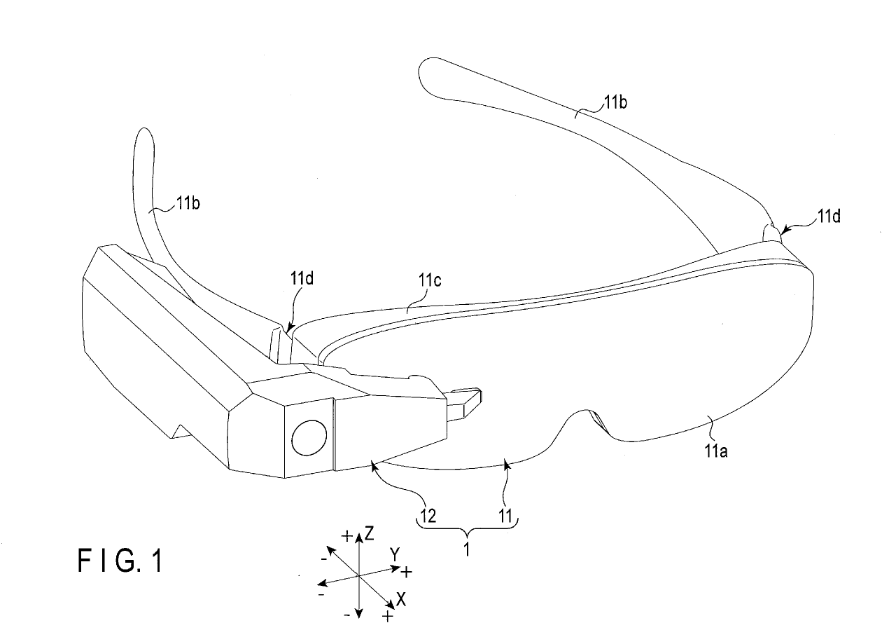

A visual information technology device 1 in an embodiment will be explained below with reference to FIG. 1 through FIG. 6 using a head-worn display with a camera as an example. FIG. 1 is a perspective view of a visual information technology device 1 in the embodiment as viewed from the front upper right. For convenience, in the following explanation, the words “front,” “back,” “right,” “left,” “upper,” and “lower” are defined with reference to the viewpoint of a user wearing the device. Moreover, the direction approaching the user's face is defined as being toward an inner side (an inner direction), and the direction receding from the user's face is defined as being toward an outer side (an outer direction). Consequently, in FIG. 1, the +X direction is forward; the +Y direction is leftward; and the +Z direction is upward. Furthermore, in each of the figures other than FIG. 1 and that will be referred to when an explanation is given later, the directions indicated by arrows X, Y, and Z correspond to the respective directions illustrated in FIG. 1.

The visual information technology device 1 of the embodiment includes, as illustrated in FIG. 1, a head mounted display 11 which is worn on a user's head, and an information processor 12 which is attached to the head mounted display 11. The head mounted display 11 constitutes a pair of glasses which have a lens section 11a and a pair of arm sections 11b. In the embodiment, the head mounted display 11 is implemented as an eye shield (goggles) for work. However, there is nothing wrong with implementing the head mounted display 11 as a normal pair of glasses. Moreover, the head mounted display is applicable to a helmet, a hat, etc., instead of glasses.

The lens section 11a is formed of a member which transmits light and covers the user's eyes, and has a windshield section 11c which extends inward from a circumferential outer edge of the lens section 11a to the user's face, thereby promoting protection of the user's eyes. The arm sections 11b are attached in a freely foldable way by respective hinges 11d to the respective ends of the lens section 11a located on the Y-axis.

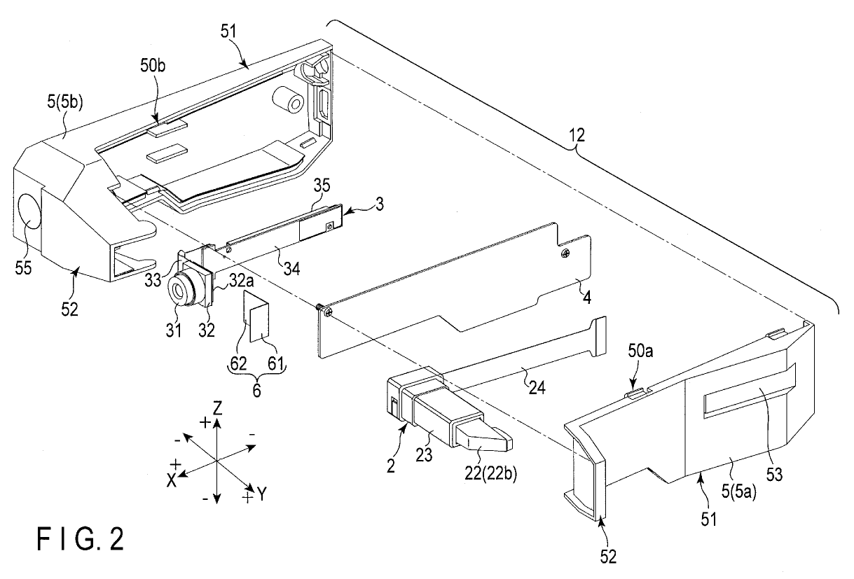

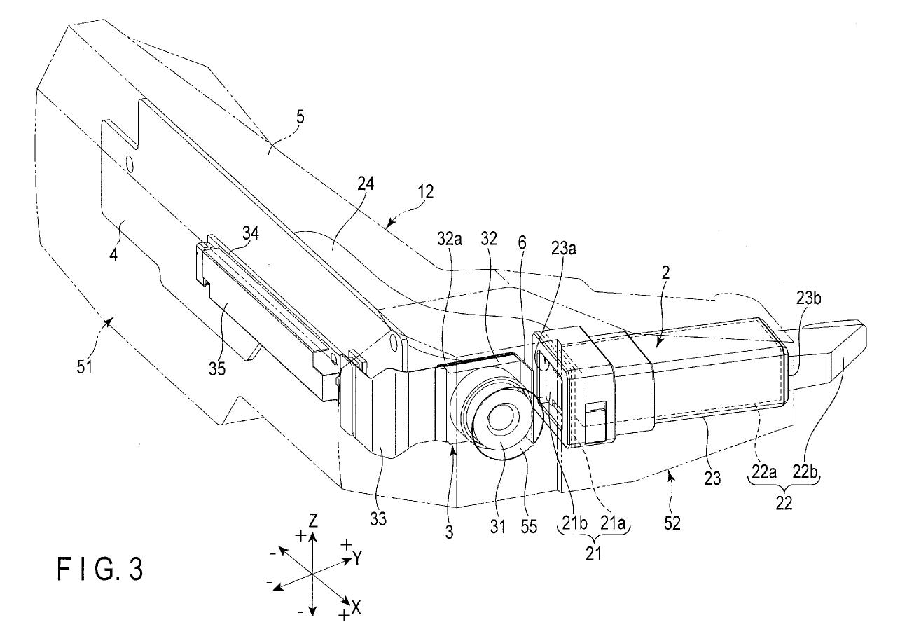

The information processor 12 of the embodiment is illustrated in FIG. 2 and FIG. 3. FIG. 2 is a perspective view illustrating the information processor 12 in a state of being disassembled into component parts. FIG. 3 is a transparent view illustrating the internal structure of the information processor 12.

As illustrated in FIG. 2 and FIG. 3, the information processor 12 has an image display 2, a camera 3, and a control base 4 that controls the image display 2 and the camera 3. The control base 4 is connected by a cable etc., to a control unit provided separately from the information processor 12. The control base 4 and the control unit may be wirelessly connected with each other. The control unit is attached to a user's waist etc., for example. It carries out selection of a display image, analysis of a captured image, etc., while supplying power through cables, the control base 4, etc., to the image display 2 and the camera 3.

As illustrated in FIG. 2, the image display 2, the camera 3, and the control base 4 are contained a case 5 which is divided into two, an inner side and an outer side. The case 5 is made of resin or metal, and approximately L-shaped two case shells 5a and 5b are fitted in to form the case 5. One case shell 5a has a hook portion (a spring member 50a), and the other case shell 5b has an eye portion (a notch 50b). By carrying out engagement of the spring member 50a to notch 50b, these case shells 5a and 5b are mutually engaged and locked together. The relation between a hook portion and an eye portion may be converse.

The information processor 12 is attached to the head mounted display 11 as follows. The bending part of each of case shells 5a and 5b is positioned in the vicinity of the same single one of the hinges 11d. A first case portion (a trunk section) 51 which mainly contains the control base 4 is arranged along the X-axis. A second case portion (a limb section) 52 which contains the image display 2 is arranged along the Y-axis. The information processor 12 is attached to one of the arm sections 11b. The information processor 12 can be attached by any arbitrary method. One of the arm sections 11b is fitted in a mounting groove 53 formed in case shell 5a in the embodiment. This makes it possible to minutely slide the information processor 12 on one of the arm sections 11b along the X-axis, thereby achieving a fine positional adjustment of the information processor 12. Instead of adopting such a mounting method, it is also possible to attach the information processor 12 to one of the arm sections 11b by, for example, a clip, a band, a hook, etc., enabling free attachment and detachment. Alternatively, the information processor 12 may be fixed to one of the arm sections 11b by a screw, adhesion, etc. Moreover, the information processor 12 may be fixed to the lens section 11a or the windshield section 11c instead of fixing the information processor 12 to one of the arm sections 11b.

The image display 2 has a display panel section 21 and a light guide projection section 22. It causes the display panel section 21 to display a picture and the light guide projection section 22 to project the displayed picture onto a retina of a user's eye, thereby forming an image on the retina. The display panel section 21 and the light guide projection section 22 are accommodated in a case 23. The case 23 is made of a light blocking effect member to have an approximately tubular shape. The display panel section 21 is connected with the control base 4 by a flexible printed circuit (FPC) panel 24 emerging from the case 23, and the display of a picture is controlled.

In the embodiment, an organic electroluminescent panel 21a is used as a picture display panel of the display panel section 21. A static image and a dynamic image, including characters, are displayed on the organic electroluminescent panel 21a. Furthermore, a liquid crystal panel, for example, may be used as a picture display panel instead of the organic electroluminescent panel 21a.

The organic electroluminescent panel 21a generates heat because an organic electroluminescent silicon driving substrate consumes electric power, and thus the panel surface which displays a picture will rise in temperature. Therefore, the display panel section 21 has a heat spreader 21b at the back side (a surface opposite to the panel surface) of the organic electroluminescent panel 21a. The heat spreader 21b is formed to have a board shape, and is arranged in such a manner that its board surface faces the opening 23a located at one side (a base end side) of the case 23. Accordingly, the heat emitted from the organic electroluminescent panel 21a will be exhausted through the heat spreader 21b to the back side of the organic electroluminescent panel 21a. As a result, the organic electroluminescent panel 21a will be suppressed in degradation which is caused by a temperature rise, and thus extension of life-span will be attained.

The light guide projection section 22 uses a condenser lens 22a to condense the light (image light) emitted from the picture which the organic electroluminescent panel 21a displays, and uses a light guide lens 22b to guide or project the condensed image light to or on a user's eye (retina). The condenser lens 22a is accommodated in the case 23, and is arranged ahead of the traveling direction of the image light with respect to the organic electroluminescent panel 21a. The light guide lens (prism) 22b sticks out of the case 23 from the opening 23b at the tip side of the case 23, and is arranged further ahead of the traveling direction of the image light in comparison with the condenser lens 22a.

The image display 2 which has such a structure is contained the limb section 52 formed of case shells 5a and 5b with the base end side of the case 23 being inserted into the limb section 52. When the information processor 12 is attached to one of the arm sections 11b, the image light of the organic electroluminescent panel 21a is caused to travel in the direction +Y within the case 5. The light guide lens 22b protruding from the case 23 also protrudes from the case 5. And the light guide lens 22b protruding from the case 5 is positioned in front of the lens section 11a. In that case, the mounting position of the information processor 12 can be adjusted with respect to the arm sections 11b so that the light guide lens 22b may be suited in position to the user's eyes. This allows external light to pass through the light guide lens 22b and to enter the user's eyes. Consequently, what the user can see is a scene in which an image projected from the light guide lens 22b is placed on the background entering a visual field.

The camera 3 includes a lens section 31 and an image pickup device section 32, and capture images including a user's visual field. The lens section 31 includes a body tube and a lens in the body tube. The image pickup device section 32 is connected with a camera control section 34 by a camera FPC 33, and converts the light concentrated by the lens section 31 into electric information. In the embodiment, a complementary metal oxide semiconductor (CMOS) is used as an image pickup device of the image pickup device section 32. However, it is also possible to use another image pickup device, such as a charge-coupled device (CCD), instead of the CMOS.

The image pickup device section 32 has a metal reinforcing plate 32a on the back side (the surface which is opposite to the lens section 31). The camera control section 34 has a substrate on which a circuit is formed. The side on which the circuit is formed is covered with a shield section 35. The shield section 35 is a plate made of metallic materials (a metal plate), and covers the circuit formed side of the camera control section 34. This prevents external noises, such as electromagnetic waves, from affecting a signal conversion which the image pickup device section 32 executes.

The camera 3 has such a structure. The lens section 31 and the image pickup device section 32 are contained the limb section 52 formed of case shells 5a and 5b. The camera FPC 33, the camera control section 34 and the shield section 35 are contained the trunk section 51 formed of case shells 5a and 5b. The camera control section 34 and the control base 4 are arranged to be confronted with each other in such a manner that the respective substrates keep a predetermined space in between along the Y-axis. The lens section 31 and the image pickup device section 32 are individually arranged at a predetermined distance away from the display panel section 21 along the Y-axis.

The lens section 31 and the image pickup device section 32 are fixed to case shell 5b. The lens section 31 and the image pickup device section 32, which are fixed to case shell 5b in the embodiment, are located in the −Y side portion (right half) of an imaginary X-Y plane if case shell 5b be divided into two equal portions by an imaginary X-Z plane. In this particular case, the display panel section 21 divides case shell 5b into two halves, the +Y side portion (left half) and the −Y side portion (right half), and the lens section 31 and the image pickup device section 32, which are fixed to case shell 5b, are located in the −Y side portion (right half).

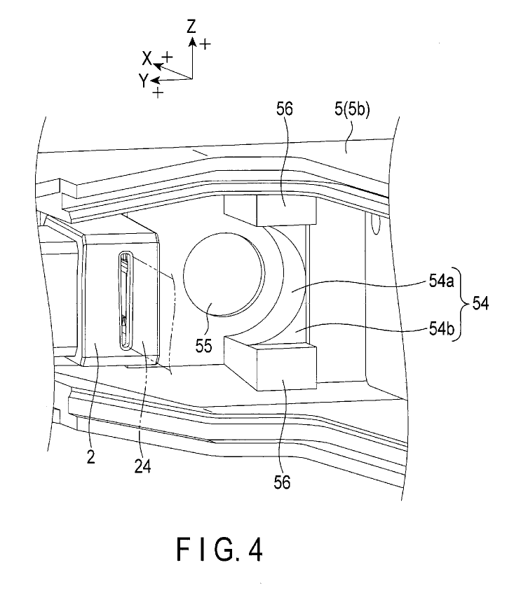

As illustrated in FIG. 4, a holding section (henceforth a camera lens holding section) 54 is formed in case shell 5b. The camera lens holding section 54 corresponds in form to the −Y side portion (right half) of each of the lens section 31 and the image pickup device section 32. The camera lens holding section 54 has a concave portion 54a, which is dented to the right direction (the direction of −Y) to fit to the lens section 31, and a concave portion 54b, which is dented to the front direction (the direction of +X) to fit to the image pickup device section 32.

The lens section 31 and the image pickup device section 32, which are fixed to case shell 5b, individually have two equal halves along the Y-axis, one of the equal halves being near the heat spreader 21b and receiving heat from the heat spreader 21b, and the other of the equal halves being far from the heat spreader 21b and scarcely receiving heat from the heat spreader 21b. The lens section 31 and the image pickup device section 32 are arranged in such a manner that their respective sides which scarcely receive heat are in contact with case shell 5b but that their respective sides which do receive heat face the heat spreader 21b with leaving in between a predetermined space extending along the Y-axis. That is, there is a body of air between the heat spreader 21b and the combination of the lens section 31 and the image pickup device section 32. Accordingly, heat exhausted from the heat spreader 21b while the organic electroluminescent panel 21a displays an image is hardly transmitted through case shell 5b to the lens section 31 and the image pickup device section 32.

It should be noted that there is nothing wrong with bring the heat receiving side of each of the lens section 31 and the image pickup device section 32 into contact with case shell 5b if the case 5 be formed of, for example, thermally low conductive resins. Moreover, so long as the size and weight stay within limits permitted as the information processor 12, it is possible to place heat insulating material, instead of the body of air, between the heat spreader 21b and the combination of the lens section 31 and the image pickup device section 32. In both cases, heat will be prevented from directly spreading to the lens section 31 and the image pickup device section 32.

The lens section 31 is received in and held by the concave portion 54a of the camera lens holding section 54, and is inside a transparent cover 55 attached to the opening formed in case shell 5b. In the condition that the information processor 12 is attached to one of the arm sections 11b, the lens of the lens section 31 is made to face in the +X direction, and the concentrating direction of the lens is made to point in the −X direction. This structure makes it possible to cause the lens section 31 to capture images including a user's visual field, and to cause the image pickup device section 32 to take pictures.

The information processor 12 of the embodiment further has a heat transfer member 6 which detours around the camera 3 and conducts heat emitted from the image display 2. The heat transfer member 6 is made of a sheet of metal high in thermal conductivity, such as copper and aluminum, for example.

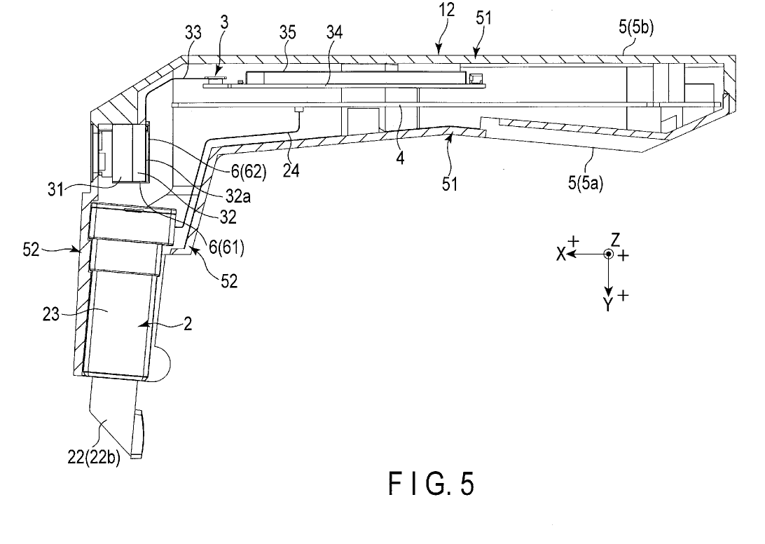

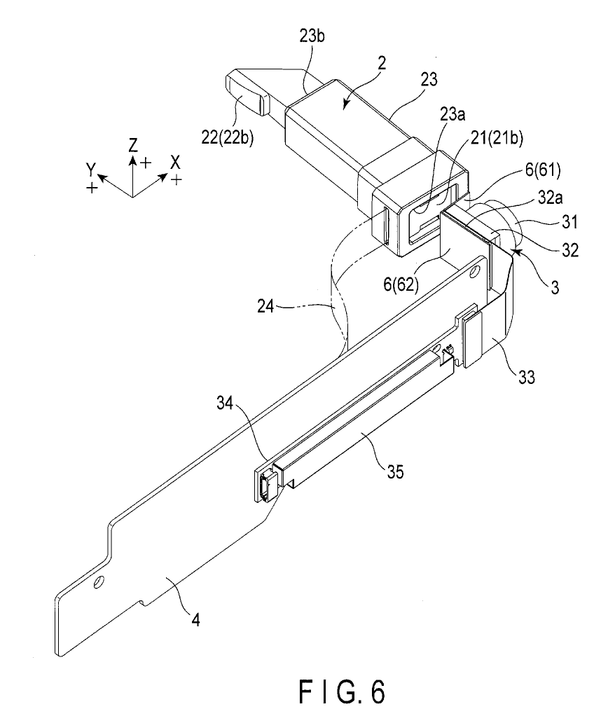

FIG. 2, FIG. 3, FIG. 5, and FIG. 6 individually illustrate the heat transfer member 6 of the first embodiment. FIG. 5 illustrates the heat transfer member 6 in a cross-section parallel to the X-Y plane (horizontal plane) of FIG. 3. FIG. 6 is a perspective view illustrating the heat transfer member 6 from a viewpoint different from that of FIG. 3. As illustrated in FIG. 2, FIG. 3, FIG. 5, and FIG. 6, the heat transfer member 6 has a first portion 61 and a second portion 62. The first portion 61 is between the image display 2 and the camera 3, and receives heat emitted from the image display 2 (hereinafter it will be referred to as a heat receiving section 61). In the embodiment, the heat receiving section 61 is arranged near the heat receiving side of each of the lens section 31 and the image pickup device section 32. Specifically, the heat receiving section 61 near the heat receiving side extends along the X- and Z-axes, and protects the lens section 31 and the image pickup device section 32 from heat. The heat receiving section 61 extends along the X-axis from the rear of the lens section 31 to the back end section of the image pickup device section 32. The heat receiving section 61 extends along the Z-axis to cover the entire length of each of the lens section 31 and the image pickup device section 32.

The second section 62 is a heat dissipation section which is seamlessly connected to the heat receiving section 61, and emits heat which the heat receiving section 61 receives (henceforth referred to as the heat dissipation section 62). In the embodiment, the heat transfer member 6 is crooked almost at right angle between the heat receiving section 61 and the heat dissipation section 62, and the heat dissipation section 62 is arranged at the back (rear surface) of the reinforcing plate 32a of the image pickup device section 32. In this case, the heat dissipation section 62 extends along the X- and Y-axes to entirely cover the back of the image pickup device section 32, specifically, the back of the reinforcing board 32a. The heat dissipation section 62 extends along the Y-axis to cover the entire length of the reinforcing board 32a that extends along the Y-axis. The heat dissipation section 62 extends along the Z-axis to cover the entire length of the reinforcing board 32a that extends along the Z-axis.

The fixed method of the heat transfer member 6 is not particularly restricted. For example, the heat dissipation section 62 may be stuck on the back of the reinforcing board 32a with adhesives etc. The fixed heat transfer member 6 is contained the case 5 along with the image display 2, the camera 3 and the control base 4 without touching the inner wall of the case 5.

In the first embodiment, even if heat is discharged from the organic electroluminescent panel 21a through the heat spreader 21b, the heat will be received by the heat receiving section 61 of the heat transfer member 6. Therefore, it will be avoided that the lens section 31 and the image pickup device section 32 directly receive the heat discharged from the organic electroluminescent panel 21a. The temperature rise of the lens section 31 and the image pickup device section 32 will be inhibited.

The heat received by the heat receiving section 61 is conducted to the heat dissipation section 62, and is transmitted from the heat dissipation section 62 to the air and the reinforcing plate 32a. The heat will be thus radiated. The reinforcing plate 32a arranged at the back side of the image pickup device section 32 will be warmed uniformly by the heat dissipation. Accordingly, the image pickup device section 32 will be prevented from a local temperature rise. The temperature distribution of the image pickup device section 32 will be thus equalized. That is, the temperature of the image pickup device section 32 will be uniform. So long as the temperature of the image pickup device section 32 will be kept uniform within the limits of operation ensuring temperature even if it rises, the image pickup device section 32 will operate normally.

Moreover, since the lens section 31 and the image pickup device section 32 may be prevented from rising in temperature, it is possible to arrange the camera 3 adjacent to the image display 2. Accordingly, the miniaturization and weight reduction of the information processor 12 will be achieved. Therefore, even if the information processor 12 is attached to the front side of the head mounted display 11, the weight balance of the visual information technology device 1 will not come undone. A stable attachment of the visual information technology device 1 will be achieved. Moreover, the bending part of the information processor 12 (plainly speaking, the angle section of the visual information technology device 1) becomes simple in structure. Consequently, the visual information technology device 1 will be improved in design.

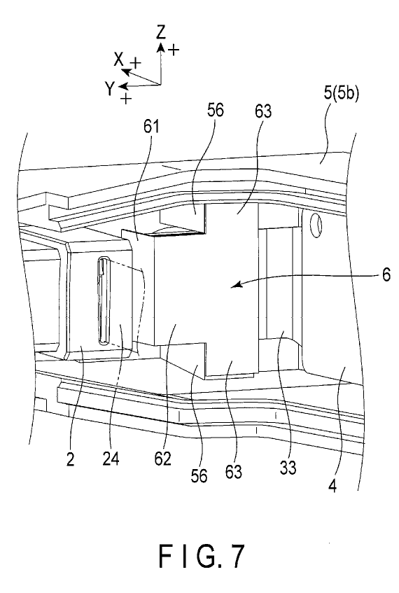

The first embodiment has been described above. The first embodiment however is nothing but one of various embodiments. For example, FIG. 7 through FIG. 9 illustrates a second embodiment through a fourth embodiment, in which the heat transfer member 6 efficiently transmits and radiates heat emitted from the organic electroluminescent panel 21a.

The visual information technology device 1 in each of the second through the fourth embodiment will be explained below. It should be noted that these embodiments are different from the first embodiment in the form and installation region of the heat transfer member 6. In each embodiment, the element which has the same function as the element of the visual information technology device 1 of the first embodiment is assigned with the same referential mark as the first embodiment, and thus the reader will easily find the detailed explanation of the element in the corresponding description of the first embodiment.

The visual information technology device 1 in the second embodiment will be explained below with reference to FIG. 7. FIG. 7 is a perspective view illustrating the heat transfer member 6 of the second embodiment. As illustrated in FIG. 7, the heat transfer member 6 has a pair of third portions (henceforth a pair of case contact sections) 63 that extends from the second portion (a heat dissipation section) 62 and touches the case 5. Specifically, the heat transfer member 6 is so constructed that the heat dissipation section 62 covers the back side of an image pickup device section 32 (reinforcing plate 32a) and the pair of case contact sections 63 touches the case 5. The pair of case contact sections 63 extends the heat dissipation section 62 so as to extend the heat transfer area of the heat transfer member 6 to the case 5. In the present embodiment, one of the pair of case contact sections 63 is at an upper part and the other of the pair of case contact sections 63 is at a lower part, thereby extending the heat dissipation section 62 along the Z-axis. The camera lens holding section 54 of case shell 5b has an upper projection section 56 and a lower projection section 56 (as illustrated in FIG. 4). One of the pair of case contact sections 63 at the upper part touches the upper projection section 56 and the other of the pair of case contact sections 63 at the lower part touches the lower projection section 56.

In the present embodiment, heat having been received by the heat receiving section 61 and having been conducted to the heat dissipation section 62 will be transmitted from the pair of case contact sections 63 to the respective projection sections 56. Consequently, the heat emitted from the organic electroluminescent panel 21a will spread over and will be transmitted to the case 5. For example, when the case 5 is made into a small size, a light weight, and a thin shape using a Magnesium alloy etc., the heat transfer effect from the pair of case contact sections 63 to the case 5 will become high. Consequently, the rise of the temperature of the image pickup device section 32 will be not only suppressed efficiently but also equalized effectively.

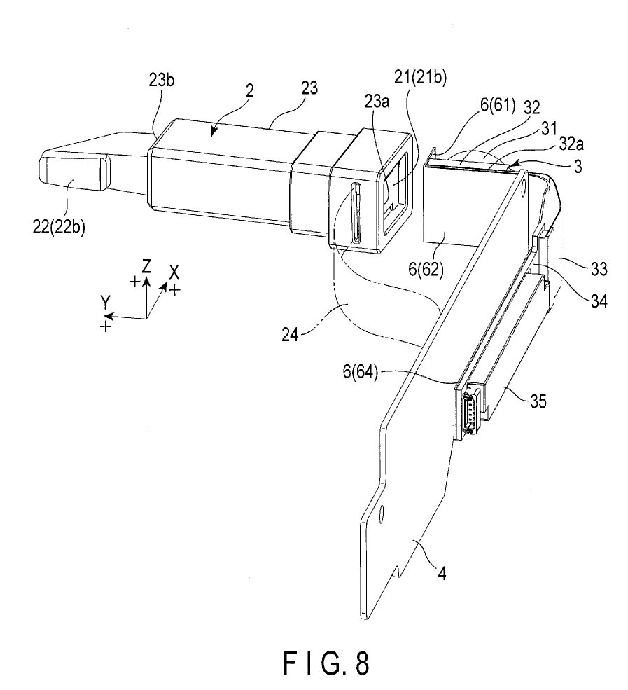

The visual information technology device 1 in the third embodiment will be explained below with reference to FIG. 8. FIG. 8 is a perspective view illustrating a heat transfer member 6 of the third embodiment. As illustrated in FIG. 8, the heat transfer member 6 has a fourth section (henceforth a control section contact section) 64 that extends from a second section (a heat dissipation section) 62 and touches a camera control section 34. Specifically, the heat transfer member 6 has a heat dissipation section 62, which covers the back of an image pickup device section 32 (a reinforcing plate 32a), and a control section contact section 64, which touches a camera control section 34. The control section contact section 64 is an extension of the heat dissipation section 62 and extends the area which transmits heat to the camera control section 34. In the present embodiment, the control section contact section 64 is at the right-hand side of the heat dissipation section 62, extends along with the X-axis as an extension of the heat dissipation section 62, and touches the substrate of the camera control section 34 at the side opposite to the circuit interconnection side of the camera control section 34 (the side covered with the shield section 35).

In the present embodiment, the heat which is received by the heat receiving section 61 and conducted to the heat dissipation section 62 will be transmitted from the control section contact section 64 to the camera control section 34. This makes it possible to diffuse the heat emitted from the organic electroluminescent panel 21a, and to transmit the heat to the camera control section 34. The control section contact section 64 is between the camera control section 34 and the control bases 4, and extends along the camera FPC 33. Consequently, it is not necessary to separately provide in the case 5 a space for arranging the control section contact section 64. Accordingly, not only the case 5 will be very compact, but also the heat dissipation effect by the heat conduction of the heat transfer member 6 will be improved.

Furthermore, it is possible that the heat dissipation section 62 may have the pair of case contact sections 63 of the second embodiment mentioned above in addition to the control section contact section 64. This makes it possible to extend the heat transfer area of the heat transfer member 6 further to the case 5 in added to the camera control section 34.

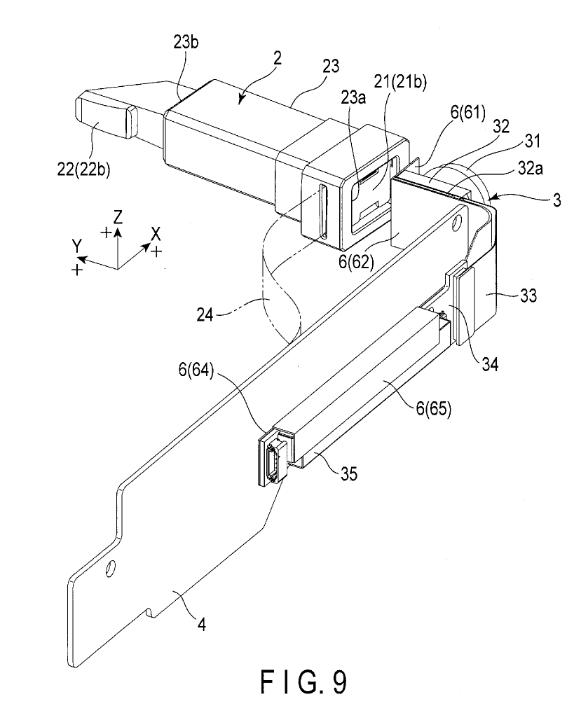

The visual information technology device 1 of the fourth embodiment will be explained below with reference to FIG. 9. FIG. 9 is a perspective view illustrating a heat transfer member 6 of the fourth embodiment. As illustrated in FIG. 9, the heat transfer member 6 has a fifth portion (henceforth a shield section contact section) 65 that extends from a fourth portion (a control section contact section) 64 and touches a shield section 35. Accordingly, the heat transfer member 6 has a heat dissipation section 62, which covers the back of an image pickup device section 32 (a reinforcing plate 32a), a control section contact section 64, which touches a camera control section 34, and a shield section contact section 65, which touches the shield section 35. The shield section contact section 65 is an extension of the heat dissipation section 62 and extends the heat transfer area of the heat transfer member 6 to the camera control section 34 and the shield section 35. In the present embodiment, the shield section contact section 65 and the control section contact section 64 form an extension of the heat dissipation section 62 that extends along the X-axis. The shield section contact section 65 is at the side were a circuit interconnection is provided for the camera control section 34, and touches the shield section 35. The shield section contact section 65 is provided on the upper side of the control section contact section 64, extends to the left, and hangs down.

It should be noted that the heat receiving section 61 is arranged near the heat receiving side of each of the lens section 31 and the image pickup device section 32 in each of the first through the fourth embodiment mentioned above. That is, in each of these embodiments, the heat receiving section 61 is arranged at the side of the camera 3. In contrast, even if the heat receiving section 61 is arranged at the side of the image display 2, the same heat dissipation effect can be acquired by the heat conduction of the heat transfer member 6.

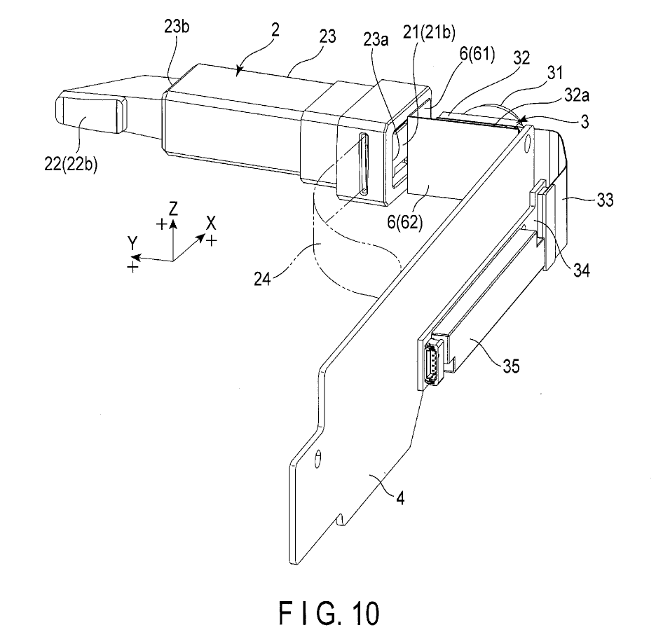

FIG. 10 illustrates a fifth embodiment in which a heat receiving section 61 is arranged at the side of an image display 2. The visual information technology device 1 of the fifth embodiment will be explained below with reference to FIG. 10. As illustrated in FIG. 10, the heat receiving section 61 of a heat transfer member 6 is arranged near a heat spreader 21b. The heat receiving section 61 extends along the X- and Z-axes like the heat transfer member 6 of the first embodiment. Although an opening 23a of a case 23 is not entirely covered with the heat receiving section 61, it is possible that the heat receiving section 61 may have a size to completely cover the opening 23a. A heat dissipation section 62 extends inwardly along the Y-axis (extends in the +Y direction) in comparison with the heat dissipation section 62 of the first embodiment by such an extent as the heat receiving section 61 shifts toward the heat spreader 21b. Consequently, the heat dissipation section 62 covers the back of the image pickup device section 32 (the reinforcing plate 32a) like the heat transfer member 6 of the first embodiment.

The present embodiment makes it possible to cause the heat receiving section 61 to more directly receive heat emitted from the organic electroluminescent panel 21a. Therefore, the present embodiment makes it possible to more stably conduct the heat emitted from the organic electroluminescent panel 21a to the heat dissipation section 62 and finally to dissipate the heat.

It should be noted that, although a graphic representation is not given, the heat receiving section 61 in each of the second through the fourth embodiment can be arranged near the heat spreader 21b like the fifth embodiment. Even in such an arrangement, the heat dissipation effect by the heat conduction of the heat transfer member 6 can be stably acquired like the fifth embodiment.

Thus, the first through the fifth embodiment, which have been described above, provide a visual information technology device 1 (for example, a head mount display to which a camera is attached) which gives special consideration to the operation ensuring temperature for a camera 3 which must be arranged near a heat source or an image display 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A visual information technology device comprising:
a head mounted display configured to be worn by a user; and
an information processor attached to the head mounted display,
the information processor comprising:
an image display to project a picture on user's eyes;
a camera to capture images comprising a user's visual field; and
a case containing the image display and the camera, and
a heat transfer member attached to the image display, the heat transfer member comprising a first portion between the image display and the camera to receive heat emitted from the image display, and a second portion extending from the first portion to radiate the heat received by the first portion.

2. The visual information technology device of claim 1, wherein
the image display comprises a display panel section to display an image, and a light guide projection section to guide the light emitted from the image displayed by a display panel section and to project the light on the user's eyes,
the camera comprises a lens section and an image pickup device section to convert the light concentrated by the lens section into electric information,
the first portion of the heat transfer member is between the display panel section and the lens section, and receives the heat emitted from the display panel section, and
the second portion of the heat transfer member is behind the image pickup device section, covers the image pickup device section, and radiates the heat transmitted from the first portion.

3. The visual information technology device of claim 2, wherein
the heat transfer member further comprises a third portion extending from the second portion to touch the case.

4. The visual information technology device of claim 2, wherein
the camera further comprises a camera control section to control the lens section and the image pickup device section, and a shield section to shield the camera control section, and
the heat transfer member further comprises a fourth portion extending from the second portion and touching the camera control section.

5. The visual information technology device of claim 4, wherein
the heat transfer member further comprises a fifth portion extending from the fourth portion and touching the shield section.

6. The visual information technology device of claim 3, wherein
the camera further comprises a camera control section to control the lens section and the image pickup device section, and a shield section to shield the camera control section, and
the heat transfer member further comprises a fourth portion extending from the second portion and touching the camera control section.

7. The visual information technology device of claim 6, wherein
the heat transfer member further comprises a fifth portion extending from the fourth portion and touching the shield section.

8. The visual information technology device of claim 2, wherein
the case comprises a holding section on the other side of the display panel from the lens section and the image pickup device section holding a part of each of the lens section and the image pickup device section.
